(19) United States
(12) Patent Application Publication
(10) Pub. No.: US 2004/0154734 A1
(43) Pub. Date: Aug. 12, 2004

(54) Apparatus and method for producing a thermoplastic resin continuous laminated sheet

(75) Inventors: Katsumi Akada, Niihama-shi (JP); Masahiro Yamasaki, Nerima-ku (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY, LIMITED; NOF CORPORATION

(21) Appl. No.: 10/742,781

(22) Filed: Dec. 23, 2003

(30) Foreign Application Priority Data
Dec. 25, 2002 (JP) P2002-374036

(51) Int. Cl. B29C 47/00

(52) U.S. Cl. 156/244.11; 425/363; 264/175

(57) ABSTRACT

An apparatus and a method for producing a thermoplastic resin continuous laminated sheet are provided. The continuous laminated sheet has at least one thermoplastic resin continuous film laminated on a thermoplastic resin continuous sheet by heat welding, and can be produced by a method comprising extruding a heat-fused thermoplastic resin continuously to be in a sheet form; rolling the extruded resin to form a thermoplastic resin continuous sheet; heating at least one lamination surface of the sheet while flatly holding the sheet; and laminating at least one thermoplastic resin continuous film onto the heated sheet.

### BACKGROUND OF THE INVENTION

1. Field of the Invention

The present invention relates to an apparatus for producing a thermoplastic resin continuous laminated sheet.

2. Description of the Background Art

Japanese Laid-open Patent Publication No. 06-270366/1994 on page 3 discloses a production apparatus (1′), such as illustrated in FIG. 3, as an apparatus for producing a thermoplastic resin continuous laminated sheet (A) (which may hereafter be simply referred to as continuous laminated sheet) in which at least one thermoplastic resin continuous film (F) (which may hereafter be simply referred to as continuous film) is laminated on a thermoplastic resin continuous sheet (S) (which may hereafter be simply referred to as continuous sheet), as illustrated in FIGS. 2a and 2b. Such a production apparatus (1′) includes a die (2) for continuously extruding to be in a sheet form, a thermoplastic resin (P) which has been heated and melted in an extruder (7), and calender rolls (3) for rolling a thermoplastic resin (P1) extruded from the die (2) to form a continuous sheet (S). More Specifically, the thermoplastic resin (P1) extruded from the die (2) is first rolled by being sandwiched between the first calender roll (31) and the second calender roll (32), and then is rolled again by being sandwiched between the second calender roll (32) and the third calender roll (33) while being wound and hung onto the second calender roll (32), thereby to form a continuous sheet (S). Immediately after the rolling, the continuous sheet (S) is wound and hung onto the third calender roll (33), and then is drawn out from the third calender roll (33). Here, immediately after the rolling, the surface temperature of the continuous sheet (S) is generally around the glass transition temperature (Tgs) of the continuous sheet (S).

This production apparatus (1′) also includes a heating device (5′) for heating the continuous sheet (S) in a state of being wound and hung onto the third calender roll (33) after the second rolling, and a laminating roll (6′) for laminating a continuous film (F) onto the heated continuous sheet (S) on the third calender roll (33). After being heated on the third calender roll (33) by the heating device (5′), the continuous film (F) is laminated onto the continuous sheet (S) on the third calender roll (33) by the laminating roll (6′).

When this production apparatus (1′) is utilized, the continuous film (F) is laminated onto the continuous sheet (S) after the continuous sheet (S) is heated, the sheet (S) having a surface temperature around the glass transition temperature (Tgs) thereof immediately after being rolled. Therefore, even if the glass transition temperature (Tgf) of the continuous film (F) is of the same temperature as or higher than the glass transition temperature (Tgs) of the continuous sheet (S), the continuous film (F) is easily laminated onto the continuous sheet (S) by heat welding to form a continuous laminated sheet (A).

However, such a conventional production apparatus (1′) has problems such that the obtained continuous laminated sheet (A) tends to be warped.

### SUMMARY OF THE INVENTION

Thus, the inventors of the present invention have made eager studies so as to develop an apparatus capable of producing a thermoplastic resin continuous laminated sheet with less warp. As a result, the inventors have found that the warp of the continuous laminated sheet may be due to heating of the continuous sheet in a state of being bent on the calender rolls, and that a continuous laminated sheet with less warp can be easily produced using an production apparatus in such a manner that, after the continuous sheet is drawn out from the calender rolls and is heated while being held flat, the continuous film is laminated onto the continuous sheet with laminating rolls, thereby arriving at the present invention.

Thus, the present invention provides an apparatus (1) and a method for producing a thermoplastic resin continuous laminated sheet (A) in which at least one thermoplastic resin continuous film (F) is laminated on a thermoplastic resin continuous sheet (S) by heat welding. The apparatus (1) comprises:

a die (2) for extruding a heat-fused thermoplastic resin (P) continuously to be in a sheet form;

calender rolls (3) for rolling a thermoplastic resin (P1) extruded from said die (2) to form a thermoplastic resin continuous sheet (S);

a holding mechanism (4) for flatly holding said thermoplastic resin continuous sheet (S) rolled by said calender rolls (3);

a heating device (5) for heating at least one lamination surface (Sa) of said thermoplastic resin continuous sheet (S) held flat by said holding mechanism (4); and

laminating rolls (6) for laminating at least one thermoplastic resin continuous film (F) onto said thermoplastic resin continuous sheet (S) heated by said heating device (5).

### BRIEF DESCRIPTION OF THE DRAWINGS

FIG. 1 shows a model view illustrating one example of an apparatus for producing a thermoplastic resin continuous laminated sheet provided by the present invention wherein each reference number or alphabet indicates the following member:

1 apparatus for producing a thermoplastic resin continuous laminated sheet

2 die

3 calender rolls

4 holding mechanism (guide rolls)

5 heating device

6 laminating rolls

7 extruder

31 first calender roll

32 second calender roll

33 third calender roll

A thermoplastic resin continuous laminated sheet

A′ thermoplastic resin leaf laminated sheets

F thermoplastic resin continuous film

P, P1 thermoplastic resin

S thermoplastic resin continuous sheet

FIGS. 2a and 2b show model views illustrating layer structures of thermoplastic resin continuous laminated sheets wherein each alphabet indicates the following member:

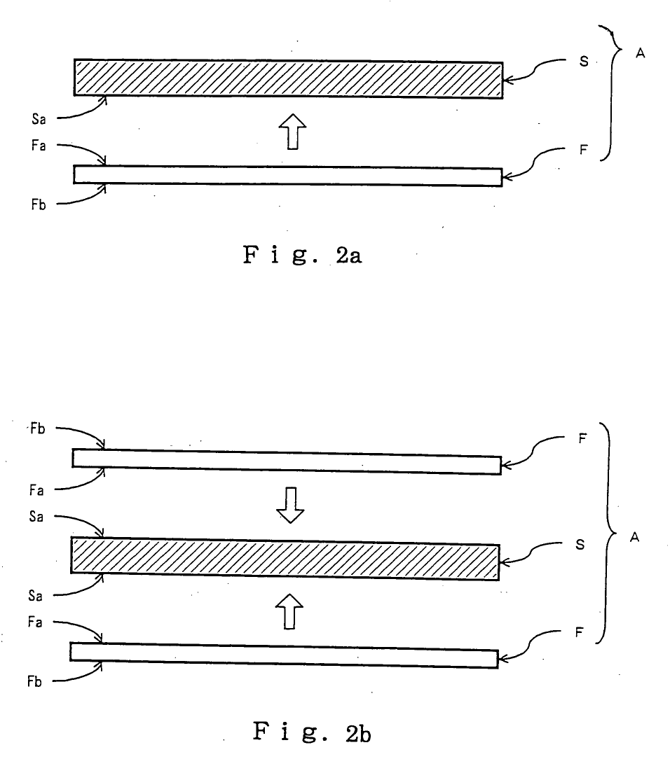

A thermoplastic resin continuous laminated sheet

F thermoplastic resin continuous film

Fa lamination surface

Fb non-lamination surface

S thermoplastic resin continuous sheet

Sa lamination surface

FIG. 3 shows a model view illustrating a conventional apparatus for producing a thermoplastic resin continuous laminated sheet wherein each reference number or alphabet indicates the following member:

1′ apparatus for producing a thermoplastic resin continuous laminated sheet

2 die

3 calender rolls

31 first calender roll

32 second calender roll

33 third calender roll

5′ heating device

6′ laminating roll

7 extruder

A thermoplastic resin continuous laminated sheet

F thermoplastic resin continuous film

P, P1 thermoplastic resin

S thermoplastic resin continuous sheet

### DESCRIPTION OF THE PREFERRED EMBODIMENTS

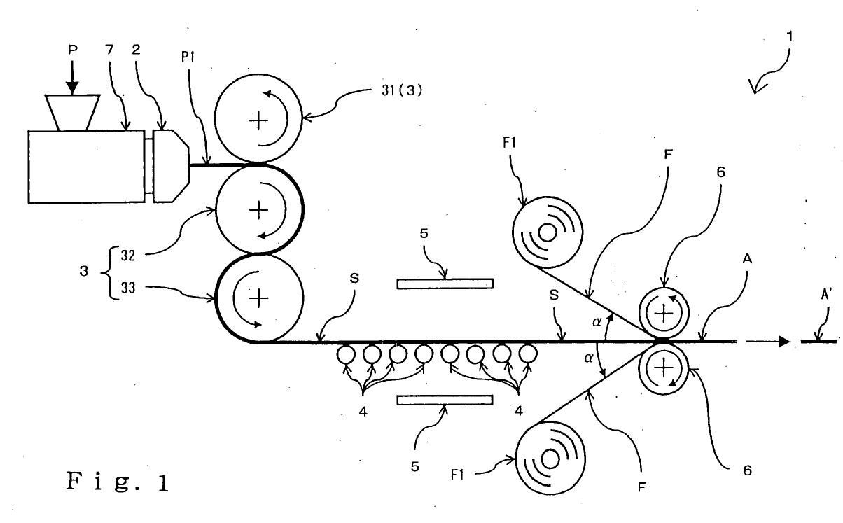

Referring to FIG. 1, one example of embodiments of the present invention is described below. FIG. 1 shows a model view illustrating one example of a production apparatus (1) provided by the present invention.

The production apparatus (1) in the present invention includes a die (2) for extruding a heated and melted thermoplastic resin (P). Examples of the thermoplastic resin (P) include acrylic resin, styrene resin, methyl methacrylate-styrene copolymer resin, polycarbonate resin, acrylonitrile-butadiene-styrene copolymer resin (ABS resin), acrylonitrile-styrene copolymer resin (AS resin), vinyl chloride resin, polyolefin resin such as polyethylene and polypropylene, polyester resin, polyacetal resin, fluororesin, nylon resin, and others. Such a thermoplastic resin (P) may include additives such as heat stabilizer, anti-oxidant, light stabilizer, ultraviolet absorber, colorant, plasticizer, and antistatic agent. Two or more kinds of thermoplastic resins (P) may be used to prepare a thermoplastic resin continuous sheet (S).

In order to heat and melt such a thermoplastic resin (P), an ordinary extruder (7) can be utilized. The thermoplastic resin (P) heated and melted while being kneaded by the extruder (7) is continuously extruded from the die (2).

For example, by using a T-die as the die (2), the thermoplastic resin (P) can be extruded to be in a film form. The die (2) may extrude the thermoplastic resin (P) to be in a monolayer form or in a multilayer form such as two-layer form or three-layer form. By using a die that extrudes the thermoplastic resin (P) to be in a monolayer form, a monolayer thermoplastic resin continuous sheet (S) can be obtained. By coextruding two or more kinds of thermoplastic resins with a plurality of extruders and a die that extrudes the resins in a multilayer form, a multilayer thermoplastic resin continuous sheet (S) can be obtained.

The production apparatus (1) in the present invention includes calender rolls (3) for rolling a thermoplastic resin (P1) extruded from the die (2) to form a continuous sheet (S). The diameter of the calender rolls (3) may be no less than about 15 cm and no more than about 60 cm. The thermoplastic resin (P1) extruded from the die (2) is rolled by the calender rolls (3). The number of the calender rolls (3) is not particularly limited as long as the number is two or more so that the calender rolls (3) can sandwich and roll the thermoplastic resin (P1). In the apparatus (1) shown in FIG. 1, three calender rolls (3) are exemplified. The extruded thermoplastic resin (P1) is first rolled by being sandwiched between the first calender roll (31) and the second calender roll (32), and then rolled again by being sandwiched between the second calender roll (32) and the third calender roll (33) while being wound and hung onto the second calender roll (32), thereby to form a continuous sheet (S).

The rolled continuous sheet (S) may have a thickness of no less than about 1 mm and no more than about 20 mm, and may have a width of no less than about 200 mm and no more than about 2500 mm. Immediately after rolling, the temperature of the continuous sheet (S) may be within the range of about Tgs±20° C., where Tgs represents the glass transition temperature of the lamination surface (Sa) of the continuous sheet (S) onto which the continuous film (F) is to be laminated.

The production apparatus (1) in the present invention includes a holding mechanism (4) for flatly holding the thermoplastic resin continuous sheet (S) rolled by the calender rolls (3). The production apparatus (1) illustrated in FIG. 1 includes a plurality of guide rolls (4) which are arranged and disposed along a horizontal plane, as the holding mechanism (4). Such guide rolls (4) may be, for example, commercially available ones which are sold as a roller table for use. The continuous sheet (S) is conveyed while being held flat by the holding mechanism (4). Here, the continuous sheet (S) need not be held exactly flat, and may be held generally flat so that no stress may remain.

The production apparatus (1) in the present invention includes a heating device (5) for heating the continuous sheet (S) held flat by the holding mechanism (4). The heating device (5) heats the continuous sheet (S) on the guide rolls (4). Examples of the heating device (5) include a heating device such as an electric heater, an infrared heater and a warm-air heater. It is sufficient to heat the lamination surface (Sa) of the continuous sheet (S) onto which the continuous film (F) is to be laminated. When at least one continuous film (F) is to be laminated onto each surface of the continuous sheet (S), it is preferred to heat both surfaces of the continuous sheet (S). When at least one continuous film (F) is to be laminated onto one surface of the continuous sheet (S), only one or both lamination surfaces (Sa) of the continuous sheet (S) may be heated.

The production apparatus (1) in the present invention includes laminating rolls (6) for laminating a continuous film (F) onto the continuous sheet (S) heated by the heating device (5). The laminating rolls (6) are typically used as a pair, as illustrated in FIG. 1. A pair of laminating rolls (6) may be constructed so as to be driven to rotate and draw out the continuous sheet (S) from the calender rolls (3) as drawing rolls. Further, the laminating rolls (6) may be constructed so as to be driven to rotate in synchronization with the calender rolls (3) so that the rolled continuous sheet (S) may be drawn out substantially with no extending force applied to the continuous sheet (S). The laminating rolls (6) may be metal rolls having a surface formed of a metal material such as stainless steel; however, the laminating roll that is brought into contact with the continuous film (F) is preferably rubber roll having a surface formed of a rubber material so that, among the two surfaces of the continuous film (F), the non-lamination surface (Fb) opposite to the lamination surface (Fa) that is to be laminated onto the continuous sheet may not be easily damaged. The diameter of the laminating rolls (6) may be no less than about 5 cm and no more than about 30 cm.

Examples of the thermoplastic resin continuous film (F) include an acrylic resin film, a styrene resin film, a methyl methacrylate-styrene copolymer resin film, a polycarbonate resin film, an ABS resin film, a vinyl chloride resin film, a polyolefin resin film, a polyester resin film, a polyacetal resin film, a fluororesin film such as polyvinylidene fluoride (PVDF) resin film, a nylon resin film and a film comprising thereof. Those that are capable of being laminated onto the lamination surface (Sa) of the thermoplastic resin continuous sheet (S) by heat welding are suitably selected as the continuous film (F). The thickness of the continuous film may be no less than about 50 μm and no more than about 1000 μm, and the width thereof may be of the same as that of the continuous sheet (S). The continuous film (F) is typically wound out from a raw film roll (F1) by lamination rolls (6), and then is introduced into a gap between the lamination rolls (6) so as to be sandwiched therebetween together with the continuous sheet (S) for lamination by heat welding.

The thermoplastic resin continuous film (F) may contain elastic particles. A continuous film (F) that contains elastic particles is excellent in flexibility and can be handled with comparatively easily. Examples of the elastic particles include acrylic ester copolymer rubber particles, polybutadiene rubber particles, styrene-butadiene copolymer rubber particles, butadiene-acrylic ester copolymer rubber particles, and others. Further, the thermoplastic resin continuous film (F) may contain additives such as heat stabilizer, anti-oxidant, light stabilizer, ultraviolet absorber, colorant, plasticizer, and antistatic agent. The thermoplastic resin continuous film (F) may be a monolayer film or may be a multilayer film in which two or more kinds of films are laminated.

The lamination surface (Fa) of the thermoplastic resin continuous film (F) may be untreated or may be subjected to surface treatment so as to facilitate heat welding with the continuous sheet. The non-lamination surface (Fb) also may be untreated or may have, for example, a surface treatment layer disposed thereon. Examples of the surface treatment layer include a hard coat layer. By disposing the hard coat layer, a continuous laminated sheet (A) having a sufficiently high surface hardness can be obtained. Further, an anti-reflection layer may be disposed on the hard coat layer. The thickness of the surface treatment layer may be from about 0.1 μm to about 50 μm.

The production apparatus (1) in the present invention is preferably used when the glass transition temperature (Tgf) of the lamination surface (Fa) of the continuous film (F) is no less than the temperature (Tgs −30° C.) that is lower by 30° C. than the glass transition temperature (Tgs) of the lamination surface (Sa) of the continuous sheet (S), more preferably no less than the temperature (Tgs −20° C.) that is lower by 20° C. than the glass transition temperature (Tgs), and is no more than the temperature (Tgs +40° C.) that is higher by 40° C. than the glass transition temperature (Tgs). For example, the production apparatus (1) in the present invention is preferably used when the continuous sheet (S) comprises at least one continuous sheet selected form an acrylic resin continuous sheet or a methyl methacrylate-styrene copolymer resin, while the continuous film (F) comprises at least one continuous film selected from an acrylic resin film, a methyl methacrylate-styrene copolymer resin film, a styrene resin film, an ABS resin film, a fluororesin film, a nylon resin film, or the like.

It is noted that the glass transition temperature(Tgf) of the lamination surface (Fa) of the continuous film (F) means the glass transition temperature of the upmost surface of the continuous film (F), the surface facing the continuous sheet (S) when laminated thereon. Similarly, the glass transition temperature (Tgs) of the lamination surface (Sa) of the continuous Sheet (S) means the glass transition temperature of the upmost surface of the continuous sheet (S), the surface facing the continuous film (F) when laminated thereon.

The thermoplastic resin continuous film (F) is preferably laminated onto the thermoplastic resin continuous sheet (S) immediately after the sheet (S) is heated by the heating device (5). For example, The continuous film (F) is preferably laminated onto the continuous sheet (S) by the laminating rolls (6) in a state in which the temperature of the lamination surface (Sa) is no less than the temperature (Tgf +5° C.) that is higher by 5° C. than the glass transition temperature (Tgf) of the lamination surface (Fa) of the continuous film (F), and is no more than the temperature (Tgs +50° C.) that is higher by 50° C. than the glass transition temperature (Tgs) of the lamination surface (Sa) of the continuous sheet (S). The continuous film (F) is preferably laminated onto the continuous sheet (S) by the laminating rolls (6) in a state in which the continuous sheet (S) is maintained to be held flat even after being heated.

In the case where a film having a surface treatment layer formed thereon is to be used as the thermoplastic resin continuous film (F), the continuous film (F) is preferably introduced into a gap between the laminating rolls (6) at an introduction angle (α) of about 90° or less. This is because, if the continuous film (F) is largely bent, cracks are liable to be created in the surface treatment layer. Here, the introduction angle (α) is an angle of the thermoplastic resin continuous film (F) relative to the thermoplastic resin continuous sheet (S), and is a value exceeding 0° and less than 180°. It may happen that, when the continuous film (F) is introduced at an introduction angle (α) of less than 90°, the continuous film (F) wound out from the raw film roll (F1) may interfere with the calender rolls (3), holding mechanism (4), heating device (5), and others. In this case, a heating device having a lower height may be suitably selected as the heating device (5), or the heating device (5) may be disposed so as to be close to the continuous sheet (S) while using guide rolls having a small diameter as the holding mechanism (4), or the distance between the calender rolls (3) and the laminating rolls (6) may be set to be large. The production apparatus (1) in the present invention is constructed in such a manner that, after the continuous sheet (S) rolled by the calender rolls (3) is heated, the continuous film (F) is laminated onto the continuous sheet (S) by the laminating rolls (6). Therefore, the distance between the calender rolls (3) and the laminating rolls (6) can be set to be large.

In accordance with the production apparatus (1) in the present invention, after the heated and melted thermoplastic resin (P) is extruded to be in a sheet form and is rolled to form a thermoplastic resin continuous sheet (S), the lamination surface (Sa) of the continuous sheet (S) is heated while the continuous sheet (S) is being held flat, and then the continuous film (F) is laminated onto the thermoplastic resin continuous sheet (S). Therefore, the thermoplastic resin continuous laminated sheet (A) can be produced without generating warp. The obtained continuous laminated sheet (A) is, for example, cut into pieces having a predetermined length, so as to form thermoplastic resin leaf laminated sheets (A′).

As disclosed above, in accordance with the production apparatus in the present invention, a rolled thermoplastic resin continuous sheet is heated while being held flat, and then, a thermoplastic resin continuous film is laminated onto the thermoplastic resin continuous sheet by heat welding with the laminating rolls. Therefore, a thermoplastic resin continuous laminated sheet can be continuously produced without generating warp.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2002-374036 filed on Dec. 25, 2002, indicating specification, claims, drawings and summary, are incorporated herein by reference in their entirety.

### EXAMPLES

The present invention is described in more detail by following Examples, which should not be construed as a limitation upon the scope of the present invention.

### Example 1

Referring to FIG. 1, an acrylic resin (glass transition temperature: 100° C.) was kneaded while being heated and melted with the use of a 40 mm extruder (7), extruded at 265° C. from a T-die (2), was sandwiched between the first calender roll (31) (diameter: 200 mm) made of stainless steel and the second calender roll (32) (diameter: 200 mm) made of stainless steel and then was wound and hung onto the second calender roll (32), and was subsequently sandwiched between the second calender roll (32) and the third calender roll (33) for rolling (diameter: 200 mm) made of stainless steel, so as to produce an acrylic resin continuous sheet (S) (thickness: 2 mm, width: 200 mm) in a continuous manner. Immediately after leaving from the third calender roll (33), the temperatures of the two surfaces of the acrylic resin continuous sheet (S) were both 101° C.

Immediately after the rolling, only the upper surface of the acrylic resin continuous sheet (S) was heated with the use of an electric heater (5) from above while being drawn out using a pair of laminating rolls (6) (diameter 100 mm) made of hard rubber and while being held flat on a plurality of guide rolls (4). Together with the heated acrylic resin continuous sheet (S), an acrylic resin film (F) (thickness125 μm, glass transition temperature (Tgf) of the lamination surface 88° C.) was introduced into a gap between the laminating rolls (6) at an introduction angle (α) of 60° for sandwiching so as to overlap the heated surface of the acrylic resin continuous sheet (S), and is press-bonded to form an acrylic resin continuous laminated sheet (A) in which the acrylic resin film (F) is laminated by heat welding onto only one surface (upper surface) of the acrylic resin continuous sheet (S). Here, immediately before being sandwiched between the calender rolls (6), the temperature of the lamination surface (Sa) of the acrylic resin continuous sheet (S) was 97° C. Further, the acrylic resin continuous sheet (S) was sent to the gap between the laminating rolls (6) while being kept flat even after being heated. The obtained acrylic resin continuous laminated sheet (A) had no warp. It was found out that, in the laminated sheet (A), the acrylic resin continuous sheet (S) and the acrylic resin continuous film (F) had been laminated together at a sufficient strength by heat welding.

### Example 2

An acrylic resin continuous laminated sheet (A) was obtained by an operation similar to that of Example 1 except that the output of the electric heater (5) was increased so that the temperature of the lamination surface (Sa) of the acrylic resin continuous sheet (S) would be 106° C. immediately before being sandwiched between the calender rolls (6). The obtained acrylic resin continuous laminated sheet had no warp. It was found out that, in the laminated sheet, the acrylic resin continuous sheet and the acrylic resin continuous film had been laminated together at a sufficient strength by heat welding.

### Example 3

An acrylic resin continuous laminated sheet (A) was obtained by an operation similar to that of Example 1 except that the output of the electric heater (5) was increased so that the temperature of the lamination surface (Sa) of the acrylic resin continuous sheet (S) would be 115° C. immediately before being sandwiched between the laminating rolls (6). The obtained acrylic resin continuous laminated sheet (A) had no warp. It was found out that, in the laminated sheet (A), the acrylic resin continuous sheet (S) and the acrylic resin continuous film (F) had been laminated together at a sufficient strength by heat welding.

### Example 4

An acrylic resin continuous laminated sheet (A) having an acrylic resin continuous sheet (S) with, on its each side, a thermoplastic resin continuous film (F) thermally welded to the sheet (S) was obtained by an operation similar to that of Example 1 except that both surfaces of the acrylic resin continuous sheet (S) were heated by two electric heaters (5) respectively disposed over/under the two sides of the acrylic resin continuous sheet (S) and that the same acrylic resin continuous films (F) as used in Example 1 were introduced, each of which was superposed onto each surface of the sheet (S) at the same introduction angle (α) as in Example 1, so as to be sandwiched and pressurized between the laminating rolls (6). Here, immediately before being sandwiched between the laminating rolls (6), the temperatures of the lamination surfaces (Sa) of the acrylic resin continuous sheet (S) were 111° C. on one surface and 112° C. on the other surface. The obtained acrylic resin continuous laminated sheet (A) had no warp. It was found out that, in the laminated sheet (A), the acrylic resin continuous film (F) had been laminated onto each of surfaces of the acrylic resin continuous sheet (S) at a sufficient strength by heat welding.

### Comparative Example 1

By an operation similar to that of Example 1 except that the heating by the electric heater (5) is stopped and that the laminating rolls (6) are heated, the acrylic resin continuous sheet (S) and the acrylic resin continuous film (F) cannot be laminated to each other with close adhesion.

### Comparative Example 2

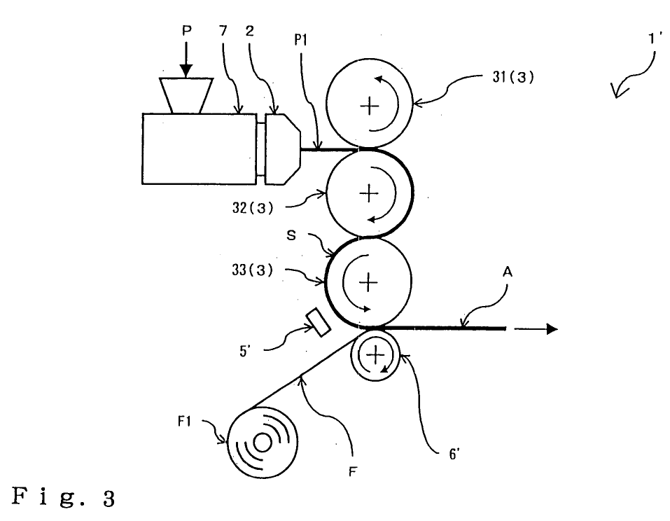

An acrylic resin continuous laminated sheet (A) having an acrylic resin continuous sheet (S) and an acrylic resin continuous film (F) laminated thereon with a sufficient adhesion by heat welding can be obtained by an operation similar to that of Example 1 except that, as illustrated in FIG. 3, a production apparatus (1′) including a heating device (5′) (for heating, after being rolled, the acrylic resin continuous sheet (S) wound and hung onto the third calender roll (33)) and a laminating roll (6′) (for laminating the acrylic resin continuous film (F) onto the acrylic resin continuous sheet (S) which has been heated on the third calender roll (33) )is used, and that the lamination surface (Sa) of the acrylic resin continuous sheet (S) is laminated at 97° C. onto the acrylic resin continuous film (F) by the laminating roll (6′) after the acrylic resin continuous sheet (S) is heated on the third calender roll (33). However, the resulting continuous laminated sheet (A) is liable to be warped.

What is claimed is

1. An apparatus for producing a thermoplastic resin continuous laminated sheet in which at least one thermoplastic resin continuous film is laminated on a thermoplastic resin continuous sheet by heat welding, said apparatus comprising
a die for extruding a heat-fused thermoplastic resin continuously to be in a sheet form;
calender rolls for rolling said thermoplastic resin extruded from said die to form a thermoplastic resin continuous sheet;
a holding mechanism for flatly holding said thermoplastic resin continuous sheet rolled by said calender rolls;
a heating device for heating at least one lamination surface of said thermoplastic resin continuous sheet held flat by said holding mechanism; and
laminating rolls for laminating at least one thermoplastic resin continuous film onto said thermoplastic resin continuous sheet heated by said heating device.

2. A method for producing a thermoplastic resin continuous laminated sheet in which at least one thermoplastic resin continuous film is laminated on a thermoplastic resin continuous sheet by heat welding, said method comprising the steps of
extruding a heat-fused thermoplastic resin continuously to be in a sheet form;
rolling said extruded thermoplastic resin to form a thermoplastic resin continuous sheet;
heating at least one lamination surface of said thermoplastic resin continuous sheet while flatly holding said thermoplastic resin continuous sheet; and
laminating at least one thermoplastic resin continuous film onto said heated thermoplastic resin continuous sheet.

3. The method according to claim 2, wherein a glass transition temperature (Tgf) of a lamination surface (Fa) of said thermoplastic resin continuous film is no less than a temperature (Tgs −30° C.) that is lower by 30° C. than a glass transition temperature (Tgs) of the lamination surface of said thermoplastic resin continuous sheet.

4. The method according to claim 3, wherein said thermoplastic resin continuous sheet comprises at least one continuous sheet selected from an acrylic resin continuous sheet and a methyl methacrylate-styrene copolymer resin continuous sheet, and said thermoplastic resin continuous film comprises at least one continuous film selected from an acrylic resin film, a methyl methacrylate-styrene copolymer resin film, a styrene resin film, an ABS resin film, a fluororesin film, or a nylon resin film.

5. The method according to claim 2, wherein said thermoplastic resin comprises at least one resin selected from acrylic resin, styrene resin, methyl methacrylate-styrene copolymer resin, polycarbonate resin, acrylonitrile-butadiene-styrene copolymer resin (ABS resin), acrylonitrile-styrene copolymer resin (AS resin), vinyl chloride resin, polyolefin resin such as polyethylene and polypropylene, polyester resin, polyacetal resin, fluororesin and nylon resin.

6. The method according to claim 2, wherein said at least one thermoplastic resin continuous film comprises at least one continuous film selected from an acrylic resin film, a styrene resin film, a methyl methacrylate-styrene copolymer resin film, a polycarbonate resin film, an ABS resin film, a vinyl chloride resin film, a polyolefin resin film, a polyester resin film, a polyacetal resin film, a fluororesin film such as polyvinylidene fluoride (PVDF) resin film and a nylon resin film.
